(19) United States
(12) Patent Application Publication
(10) Pub. No.: US 2019/0102581 A1
(43) Pub. Date: Apr. 4, 2019

(54) SHOPPING CART MONITORING SYSTEM

(71) Applicant: Walmart Apollo, LLC, Bentonville, AR (US)

(72) Inventors: Nicholaus A. Jones, Fayetteville, AR (US); Steven J. Lewis, Bentonville, AR (US)

(21) Appl. No.: 16/145,326

(22) Filed: Sep. 28, 2018

Related U.S. Application Data
(60) Provisional application No. 62/566,618, filed on Oct. 2, 2017.

(51) Int. Cl. G06K 7/08; A47F 10/04; G06Q 10/08

(52) U.S. Cl. CPC G06K 7/087; B62B 3/1404; G06Q 10/087; A47F 10/045

(57) ABSTRACT

In some embodiments, apparatuses and methods are provided herein useful to detect shopping carts and/or estimate the number of shopping carts in a specified area of a retail facility. In some embodiments, detected magnetic fields from an area are compared with values from a database to estimate the number of shopping carts present, and notifications may be provided regarding actions to be taken based on the arrangement and density of shopping carts in the area.

### RELATED APPLICATION(S)

This application claims the benefit of U.S. Provisional Application No. 62/566,618, filed Oct. 2, 2017, which is incorporated by reference in its entirety herein.

### TECHNICAL FIELD

This invention relates generally to systems for monitoring shopping carts at a specified location of a retail facility.

### BACKGROUND

Various systems have been proposed for tracking shopping carts or estimating the number of carts present in a specified area at any given time. Most often these systems require each shopping cart to be equipped with a transmitter, such as a RFID tag, which sends information regarding location or proximity to a fixed receiver device in communication with a receiver.

In some instances, these systems register when an identification tag attached to a shopping cart enters a zone defined by a specified radius from a receiver. In some prior art systems, a detector transmits queries to devices mounted to shopping carts and analyzes response signals to determine the proximity of the responding carts to a check-out area or storage area. Such systems require equipment to be placed throughout the facility as well as mounted to carts, and can result in significant power usage as devices communicate with one another over relatively large distances.

In some systems, a magnetic strip or other sensor monitors the movement of carts past specific markers or inside and outside of designated zones. However, these systems are generally incapable of determining specific locations of carts or distribution patterns within a monitored zone.

### BRIEF DESCRIPTION OF THE DRAWINGS

Disclosed herein are embodiments of systems, apparatuses and methods pertaining to detecting shopping carts and/or estimate the number of shopping carts in a shopping cart storage area of a retail facility. This description includes drawings, wherein:

FIG. 1 is a system diagram of a shopping cart detection system in accordance with some embodiments.

FIG. 2 is an illustration of a sensor mechanism and its corresponding detection zone in accordance with several embodiments.

FIG. 3 is a side view of a cart corral in accordance with some embodiments.

FIG. 4 is top view of a cart corral in accordance with several embodiments.

FIG. 5a is a side view of a cart corral with a single cart located near the entrance in accordance with some embodiments.

FIG. 5b is a graph showing sensor measurements from the corral depicted in FIG. 5a.

FIG. 6a is a side view of a cart corral with multiple carts located near the entrance in accordance with some embodiments.

FIG. 6b is a graph showing sensor measurements from the corral depicted in FIG. 6a.

FIG. 7a is a side view of a cart corral with multiple carts located throughout the corral in accordance with some embodiments.

FIG. 7b is a graph showing sensor measurements from the corral depicted in FIG. 7a .

FIG. 8a is a side view of a cart corral with multiple carts located near the far end in accordance with some embodiments.

FIG. 8b is a graph showing sensor measurements from the corral depicted in FIG. 8a.

FIG. 9 is a flow diagram depicting one method of estimating the number of shopping carts in a corral in accordance with some embodiments.

FIG. 10 is flow diagram depicting a method of managing a shopping cart storage area in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to detect shopping carts comprising ferromagnetic materials and/or estimate the number of shopping carts in a shopping cart storage area of a retail facility. A plurality of magnetic sensors are placed in a shopping cart corral or other storage area in order to detect carts positioned within a given radius from a sensor, without requiring the carts to be equipped with transmitters or other specialized devices that identify the shopping carts. Some embodiments may estimate the number of shoppers at the retail facility or monitor patterns in shopper traffic based on changes in the detected numbers of stored carts over time. In some embodiments, a control circuit of the system controls power to a plurality of sensors, receives signals from the sensors, compares detected values obtained from each magnetic sensor to threshold values from the database; and selects at least one store management option based on a comparison of the detected values to the threshold values.

The shopping carts monitored using the systems, apparatuses, and methods described herein should have a significant amount of ferromagnetic metal, such that their presence or absence may be readily detected by the sensors. The amount of metal required will depend on the sensitivity of the sensors employed. In some forms, the carts may be made entirely or almost entirely of metal, such as steel. In other forms, portions of the shopping carts may be made of plastic. Preferably, at least the vertical support connecting the wheels to the basket portion of the cart is made of steel. In preferred forms, all of the carts to be detected are of a uniform size, shape, and composition.

In some embodiments, apparatuses and methods for detecting shopping carts in a shopping cart storage area of a retail facility are provided that include structures forming a confined shopping cart storage unit having a storage volume. The storage unit may be equipped with a linear array of unidirectional magnetic field sensors placed at a relatively uniform height and configured to detect a magnitude of an induced electromagnetic field within the storage volume. A power source may be coupled to the linear array of unidirectional magnetic field sensors, and an electronic control circuit comprising a computer memory may be physically coupled to the linear array of unidirectional magnetic field sensors. Pursuant to some embodiments, the control circuit is coupled to a wireless transmitter for transmitting information from the control circuit to one or more devices monitored by one or more sales associates. The unidirectional magnetic field sensors are oriented to face the storage volume and not face volumes outside of the storage volume, and the magnitude of the electromagnetic field induced and detected by the magnetic sensors varies depending on the presence and mass of ferromagnetic materials in the storage volume. The magnetic sensors in some embodiments may be spaced apart along the length of at least one retention member forming the storage unit, and in some embodiments each magnetic sensor is supplied with an amount of power from the power source so that zones detected by the respective magnetic sensors do not overlap.

The storage unit may comprise in some embodiments an open end configured to receive and dispense the shopping carts, a closed end opposite the open end and configured to contain the shopping carts in a storage volume between the open end and the closed end, and at least two generally parallel retention members connecting portions of the open end to corresponding portions of the closed end, each retention member having a length and spaced apart from each other by a width, to form the storage volume having a length and width sized to receive a plurality of shopping carts organized in one or more single-file lines between the parallel retention members. In some embodiments, the storage unit may be open at both ends to allow carts to enter and/or exit from either side. In some embodiments the array extends along substantially the entire length of the storage areas. In some embodiments a linear array of sensors may be positioned along one or both of the retention members. If desired, two or more storage areas may be placed side-by-side, in some cases sharing an intermediate retention member, and preferably each equipped with its own sensor array. However, in some embodiments a single sensor array may be associated with multiple separate storage areas, and in some embodiments multiple arrays may be associated with a single storage area.

In some embodiments, the sensors and/or the control circuit are associated with a discriminator so that signals from the sensors that do not reach a specified value are not passed to the control circuit, allowing the control circuit to ignore “background noise” and signals from metal objects always present in the storage area. In some embodiments, the electronic control circuit is in communication with a database correlating combinations of detected values to a plurality of store management options in order to control power to each of the unidirectional magnetic field sensors such that one or more of the sensors are selectively powered on and off and such that when powered a range of each sensor is limited to the storage volume, compare detected values obtained from each magnetic sensor to threshold values from the database, and estimate a number of shopping carts present in the storage volume.

The control circuit in some embodiments is positioned in or adjacent to the storage area, and physically coupled to the sensors in order to limit interference with signals and improve reaction time. However, in some embodiments the sensors may communicate wirelessly with the control circuit, which may be positioned locally or remotely, such as at a central location within the retail facility. If the control circuit is remote or communicates with a remote server, information transmitted form the sensors may be timestamped or synchronized in order to allow comparison of contemporaneous sensor data.

In some embodiments, shopping carts may be monitored by a method that includes selectively powering on and off a linear array of unidirectional magnetic sensors that are arranged and configured so that when powered each sensor is limited to a range that is within the storage area; detecting the magnitude of induced electromagnetic fields through the linear array of unidirectional magnetic sensors; comparing detected values from each magnetic sensor to respective threshold values from a database; and transmitting a notification regarding actions to be taken by a sales associate based on the comparison of the detected values to the threshold values. In some embodiments, the notification may comprise an instruction to compact the shopping carts when a first magnetic sensor of the array at a location proximate an open end of the storage area detects an electromagnetic field exceeding its respective threshold value and a second magnetic sensor further from the open end does not detect an electromagnetic field exceeding its respective threshold value. In some embodiments, the notification comprises an instruction to retrieve shopping carts when the detected value of a preset number of sensors are at or above the respective threshold values for each magnetic sensor.

In some forms, the array of sensors may simply be used to determine which sections of a storage are completely empty. In other forms, one or more magnetic sensors may be used to detect movement of shopping cats past specific points, allowing addition and removal of carts from the storage area to be tracked. In more sophisticated embodiments, a control module compares the detected values of each sensor to stored values from a database corresponding to known positioning and/or density of shopping carts to approximate the number and/or relative density of shopping carts detected by the sensors. Changes in the approximated number of carts in the storage area over time may also be used to estimate customer traffic, so that the number of sales associates in a given area is increased or decreased at specific points in time in order to best serve customer needs without expending unnecessary resources.

The magnetic sensors may be any type of sensors suitable for detecting and measuring magnetic fields. In some embodiments the sensor comprises both a transmitter component and a receiver component. The transmitter component is configured to create a magnetic field when energized, inducing electromagnetic fields around metal objects near the transmitter. The receiver component then detects the induced electromagnetic fields and transmits an electrical signal representative of the detected fields. In some embodiments, the transmitter and receiver may be separate devices. In other embodiments, the transmitter and receiver are incorporated into a single device. In some embodiments, a single component acts as both a transmitter and receiver, such as in a pulse induction detector. In some embodiments, reed switches, magnetoresistance sensors, hall sensors, magnetometers, or other devices may be used to measure magnetic fields from objects proximate the sensor array.

In some embodiments, if the shopping cart contains little or no metal, a magnet may be positioned in the wheels or on the side of the cart. In some embodiments, especially where a magnet is placed in the wheels of a shopping cart, a magnetic reader may be positioned on the floor to read information from the cart, such as where a magnetic strip around the wheel of the cart rolls over a reader positioned on the ground. In some cases, a magnet associated with the cart could include unique information about the cart, and devices may also be positioned in a storage area or within a retail facility to encode information onto the magnet, allowing the history of the cart to be recorded as it passes various encoders at different times.

The sensors associated with a corral are preferably unidirectional, capable of detecting signals in a hemisphere to one side of the sensor only. The radius of detection for each sensor may be controlled by increasing or decreasing the energy to the sensor. By manipulating the power provided to various sensors in an array, one may limit the field of detection to a confined or designated area in order to avoid detection of objects outside the area. In some embodiments the sensors may be provided with at least 0.5 mW, or at least 1.0 mW, or at least 1.5 mW, or at least 2.0 mW, or at least 2.5 mW, or at least 3.0 mW, or at least 3.5 mW, or at least 4.0 mW, or at least 4.5 mW, or at least 5.0 mW. In some embodiments, the sensors may be provided with less than 10.0 mW, or less than 9.5 mW, or less than 9.0 mW, or less than 8.5 mW, or less than 8.0 mW, or less than 7.5 mW, or less than 7.0 mW, or less than 6.5 mW, or less than 6.0 mW, or less than 5.5 mW, or less than 5.0 mW, or less than 4.5 mW, or less than 4.0 mW, or less than 3.5 mW, or less than 3.0 mW, or less than 2.5 mW, or less than 2.0 mW. For instance, a power source may be configured to provide about 5.5 mW to a unidirectional magnetic sensor in order to detect magnetic objects within a radius of about 2 feet on one side of the sensor. The amount of energy needed to detect objects within a desired radius for any given sensor device may be determined by one of ordinary skill in the art through testing at various power levels.

Although a unidirectional sensor ordinarily detects objects within about 180 degrees of the sensor, the field in which the sensor detects signals may be further constricted by blocking areas around the sensor, such as by disposing lead shielding in one or more areas near the sensor. For instance, in specific embodiments the area detected by the sensor may be limited to a range of 150 degrees, or 120 degrees, or 90 degrees, or 60 degrees, or 45 degrees in the horizontal and/or vertical direction. This limiting of the field of detection may be used to prevent overlap in areas detected by a plurality of sensors, or may limit the horizontal and/or vertical field of detection for various reasons.

In some embodiments, magnetic sensors are positioned in arrays in order to cover areas that a single sensor could not or to isolate detection an area having an irregular shape. In some embodiments, the area to be detected is a storage corral bounded on at least two sides by approximately parallel retention beams. An array of sensors may be affixed to a beam on one or more of the beams and directed inward in order to face a storage volume between the beams. The unidirectional sensors will in this way no be directed to areas outside the storage volume, avoiding accidental detection of cars and other objects outside of the storage volume that may move over time. Permanent structures, such as the structures defining the storage area, can be taken into account in developing baseline readings for the sensors, and the sensors need not be configured to avoid detection of such structures. In some embodiments, a plurality of magnetic sensors are placed at regular intervals along the length of a storage area. In some embodiments, the sensors are positioned along a side structure of a cart storage area, or along both sides of the cart storage areas. Cart corrals and other similar storage structures are generally designed so that one or two rows of carts may be positioned therein, with relatively little additional room to each side of the carts. Magnetic sensors attached to a side barrier of the corral, therefore, need not have a large radius of detection in order to determine whether one or more carts have been positioned in front of the sensor. The sensors are preferably positioned in a linear array with each sensor having approximately the same vertical position relative to the ground.

In alternative embodiments, the sensors may be placed along the ground or suspended overhead, so that carts pass above or below the sensors, respectively. The positions of individual sensors and sensor arrays may be varied as needed in order to best monitor a given storage area. The distance between sensors may also be varied as needed. In some embodiments, only a single sensor is placed in a storage area, near the open end entrance/exit, in order to confirm that one or more carts has passed that point. In other embodiments, a sensor is positioned in each half or quarter of the length of the storage area. In some embodiments, sensors are distributed every 2 to 4 inches, or a distance approximately equal to the distance between the ends of two nested carts, along a side barrier of a cart storage area so that each sensor will detect the relatively thick support beam at the back of a cart when carts are fully nested within the storage area, so that failure to detect a magnetic field representative of such a support beam indicates that the carts are not properly nested proximate that sensor. When the sensors are tightly spaced together in this manner, the power applied to the sensors should be relatively low in order to create a small detection zone to avoid interference between sensors. Alternatively, sensors may be positioned to divide the storage area in to a specific number of zones, such as 2, 3 4, 5, 6, 7, or 8, each with a relatively large detection zone. While the detection zones of adjacent sensors may overlap, in some embodiments the spacing and the size of the detection zones are configured to avoid overlap of detection zones, and in some embodiments that are significant distances between detection zones in which no sensor detects objects.

The arrays of sensors are coupled to a control circuit to control operation of the sensors and interpret signals from the sensors. In some embodiments, the control circuit may be coupled to one or more databases containing information regarding one or more states of the section of the storage area associated with each sensor. For instance, the database may contain baseline readings from each sensor when its associated section of the storage area is empty or full, so that the control circuit may determine how close to empty or full the section is at any given time based on later signals from the sensor. The database may also, or alternatively, contain threshold values for the sensors, so that specific events such as notifications are triggered when readings form the sensors are above or below the threshold values. The database may also contain rules based on patterns of sensor values in the array. For instance, if sensors toward the open end of a cart corral transmit signals indicative of magnetic fields exceeding threshold values, indicating that shopping carts are relatively densely packed in that area, while sensors toward the closed end of the corral transmit signals below threshold values, indicating that shopping carts are absent and/or loosely packed, the control circuit may be configured to send a notification causing carts to be moved toward the closed end, such as by alerting sales associates that the carts should be pushed toward the closed end and compacted. On the other hand, if sensors toward the open end of a cart corral transmit signals indicative of magnetic fields below threshold values, indicating that shopping carts are absent in those areas, while sensors toward the closed end of the corral transmit signals above threshold values, indicating that shopping carts are densely packed, the control circuit may be configured to take no action. If all sensors indicate that carts are present in those areas and densely packed, the control circuit may be configured to cause retrieval of the carts, such as by alerting sales associates that the corral is full or by triggering an automated cart retrieval system.

A plurality of shopping cart storage areas may be linked to form a single system, each equipped with at least one array of sensors, in order to monitor storage of shopping carts throughout the retail facility. Storage areas may be inside the facility, in the neighboring parking lot, or both. In some embodiments, detecting low numbers of shopping carts at indoor cart storage areas causes a signal to be sent to the control circuit that causes the control circuit to determine which of a plurality of outdoor storage areas is most full, prompting a sales associate to retrieve carts from that storage area in order to replenish the indoor storage area.

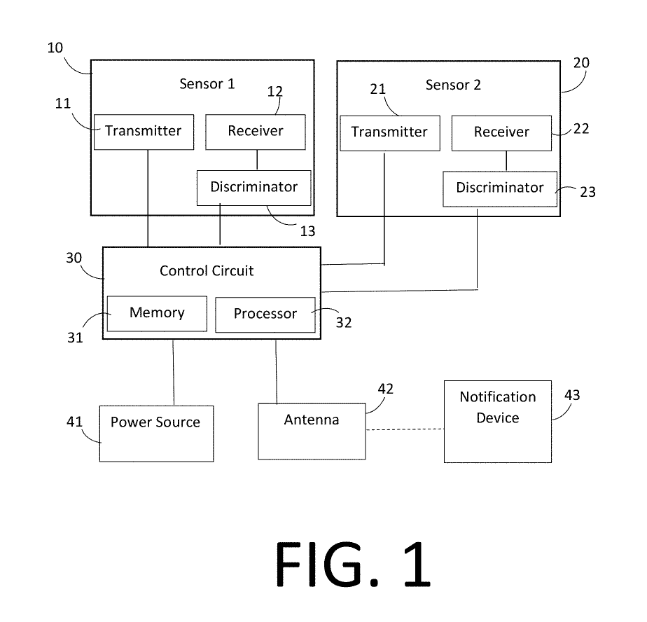

FIG. 1 is a diagram of a sensor array for use in detecting shopping carts within a cart storage area. A first sensor 10 (sensor 1) comprises a magnetic transmitter 11 to induce magnetic field in objects and a magnetic receiver 12 that detects electromagnetic fields and generates an electrical signal based upon the magnitude of the detected field. The receiver in the depicted embodiment is connected to a discriminator 13 that filters out signals from the receiver that are below a specific threshold to discriminate between signals that are meaningful and those that are not meaningful.

Similarly, a second sensor 20 (sensor 2) comprises a magnetic transmitter 21 to induce magnetic field in objects and a magnetic receiver 22 that detects electromagnetic fields and generates an electrical signal based upon the magnitude of the detected field. The receiver may be connected to a discriminator 23 that discriminates between meaningful signals and those that do not meet threshold requirements.

A control circuit 30 is coupled to each of sensors 10 and 20 in order to operate the sensors and process signals relating to detection of objects by the sensors. The control circuit 30 may include a memory module 31 and a processor 32. The term control circuit refers broadly to any microcontroller, computer, or processor-based device with processor, memory, and programmable input/output peripherals, which is generally designed to govern the operation of other components and devices. It is further understood to include common accompanying accessory devices. The control circuit can be implemented through one or more processors, microprocessors, central processing units, logic, local digital storage, firmware, software, and/or other control hardware and/or software, and may be used to execute or assist in executing the steps of the processes, methods, functionality, and techniques described herein. Furthermore, in some implementations the control circuit may provide multiprocessor functionality. These architectural options are well known and understood in the art and require no further description here. The control circuit 30 may be configured (for example, by using corresponding programming stored in a memory as will be well understood by those skilled in the art) to carry out one or more of the steps, actions, and/or functions described herein.

Generally, the control circuit 30 can include fixed-purpose hard-wired platforms or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein, and can store instructions, code, and the like that is implemented by the control circuit and/or processors to implement intended functionality. In some applications, the control circuit and/or memory may be distributed over a communications network (e.g. LAN, WAN, Internet) providing distributed and/or redundant processing and functionality. In some implementations, the control circuit can comprise a processor 32 and a memory module 31, which may be integrated together, such as in a microcontroller, application specification integrated circuit, field programmable gate array or other such device, or may be separate devices coupled together.

A power source 41 is provided that powers the transmitters 11 and 21 in order to generate electromagnetic fields. The power supply may be of any conventional type, such as a direct current electrical circuit, an alternating current electrical circuit, a battery or a solar (photovoltaic) cell. The power source 41 is coupled to the transmitter 11 of the first sensor 10 and transmitter 21 of the second sensor 20 through the control circuit 30. The control circuit 30 regulates the amount of power provided to the sensors in order to maintain the effective range of the first sensor 10 and second sensor 20 at desired values, which may be the same or different. The control circuit 30 allows for independent adjustment of the radius of detection of each sensor, and may be programmed to automatically adjust the power provided to one or more sensors based on specified conditions. The radius of detection may be increased by increasing the energy to the sensors through the control circuit 30 or decreased by decreasing the energy to the sensor through the control circuit 30.

In some embodiments, the control circuit may provide power to the transmitters 11 and 21 only intermittently in order to conserve power. In other words, the array of sensors may alternate between on and off states at predetermined time intervals in order to reduce or limit the amount of energy used by the system. For instance, the control circuit 30 may be set to only activate transmitters 11 and 21 for a short time every minute, every 5 minutes every half hour, every hour, or even every several hours to periodically scan for shopping carts within the zones monitored by each sensor. The system may also be designed to allow a user to check the status of one or more storage areas on command, such as by interfacing with the notification device. These periodic readings provide “snapshots” of the state of a storage area at any given time, but may be misleading if they capture the positioning of carts as they are being moved during the detection process. Therefore, if flux of readings is detected during the period of time in which the sensors are activated, the system may be designed to automatically activate the sensors one or more subsequent times until steady readings are obtained. Alternatively, each activation of the sensors could comprise a burst of two or more detections spaced apart by short time intervals such as 1-3 seconds, so that the system can determine whether readings in each burst are consistent.

When one or both of sensors 10 and 20 detect an electromagnetic field sufficient to produce a signal from receiver 12 and/or 22 that is within a range set by discriminators 13 and 23, respectively, the control circuit compares each signal to standards contained in a database of memory module 31. In some forms, the database may contain a single threshold value, with the control circuit associating a binary value in response to signals from each sensor. In some embodiments, the database may include a plurality of values corresponding to different numbers of carts within the zone detected by a sensor. These values may be derived by recording sensor readings when known quantities of carts are present in the detected zone. In such embodiments, the number of carts within the zone may be estimated by comparing signals from the receivers 12 and 22 to the nearest database values. When a large number of database values are provided, the control circuit will be able to more precisely estimate the quantity of carts present. The database referenced by the control circuit 30 may additionally, or alternatively, associate signals from the sensors with specific notifications or recommendations.

The control circuit 30 relays information from the database through an antenna 42 to a notification device 43. The notification device 43 provides users, such as store sales associates, with information relating to the sensors as conveyed by the control circuit. In some embodiments the notification device may be simple, for example a pager, and convey limited information regarding the status or one or more cart storage areas. In other embodiments, the notification may be a desktop computer, or a smartphone or other mobile communication device, capable of conveying substantial information regarding the status of cart storage areas over time. In some embodiments, signals from sensors that meet or exceed certain values may cause the control circuit to transmit a wireless signal to the notification device 43 indicating that one or more detected zones are full and/or that carts should be moved or retrieved. The antenna 42 preferably communicates with the notification device 43 through low-power wireless signals, such as low-power WiFi®, Bluetooth® Low Energy, ANT™, ZigBee®, or other comparable wireless technologies. However, other forms of communication between the control circuit 30 and notification device 43 may be used, and in some embodiments the control circuit 30 may be hard wired to the notification device 43.

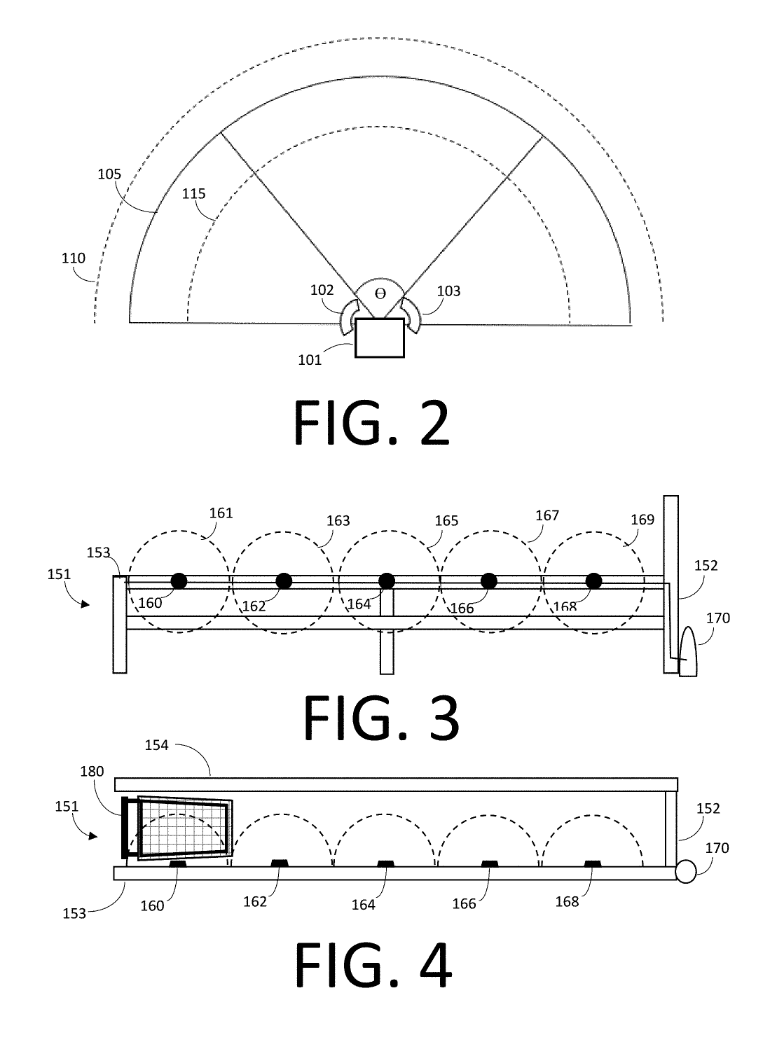

FIG. 2 illustrates how the zone monitored by a magnetic sensor 101 may be controlled. At a specified power level the sensor 101indices and detects magnetic fields within a corresponding radius, forming a roughly hemispherical zone of detection 105. When the power applied to the sensor 101 increases, the sensor detects objects within a larger zone 110. Decreasing the power applied to the sensor 101 confines detection to a smaller zone 115. The zone of detection may be narrowed from 180 degrees to a smaller angle θ by positioning lead shields 102 and 103 in front of the sensor 101. In this manner, the sensor 101 may detect objects a significant distance in front of it without also detecting an equal distance to each side, reducing or preventing overlap of adjacent sensors when placed in an array. This can be especially beneficial, for instance, where the sensor is located near an end of a storage area and detection of objects outside of the area is to be avoided.

FIG. 3 illustrates a side view of a cart corral in connection with some embodiments of the invention. The corral includes an open end 151 through which shopping carts enter the corral and a closed end 152. A retention member 153 runs from the open end 151 to the closed end 152 and forms a side barrier to confine shopping carts to the storage area. A plurality of magnetic sensors (160, 162, 164, 166, and 168) are positioned at intervals along the retention member 153 to form a linear array. The array of sensors is physically connected to a control module 170 which receives signals from each sensor and regulates the operation of the sensors. Sensor 160 detects metal objects within a hemispherical zone 161, sensor 162 detects metal objects within a hemispherical zone 163, sensor 164 detects metal objects within a hemispherical zone 165, sensor 166 detects metal objects within a hemispherical zone 167, and sensor 168 detects metal objects within a hemispherical zone 169. Although the illustrated zones are non-overlapping, in some embodiments they may be made to overlap by positioning sensors closer to one another or increasing the power to one or more sensors in order change the size of respective detection zones. In addition, although the zones for each sensor are the same size, the size and shape of each zone may be individually modified as desired to suit various needs. The spacing between sensors need not be uniform, and height of the sensors may vary. It is beneficial, but not necessary, to have each sensor positioned at approximately the same height from the ground, creating a horizontal array of sensors having a uniform height.

FIG. 4 depicts the shopping cart corral of FIG. 3 from an overhead view. The corral is bounded on one side by side retention member 153 equipped with sensors 160, 162, 164, 166, and 168; on a second side by opposing side retention member 154; and at the far end by end retention member 152. A storage volume is thus formed between the three retention members, and open only at one end. A shopping cart 180 has entered at open end 151, and the distance between side retention members 153 and 154 is slightly larger than the width of the shopping cart so that carts may pass easily through the corral. The distance between side retention members 153 and 154 allows for only a single row of shopping carts, and should make it impossible for a cart to pass through the corral without entering the zone detected by at least one sensor. For instance, if the shopping cart is 2-4 feet wide, the distance between parallel retention members may be about 6 inches wider, leaving approximately 3 inches on each side of carts when they are centered, in order to allow carts to easily enter but ensure that the carts align in a row and nest easily. In alternative embodiments, the side retention members 153 and 154 may be spaced further apart to allow to rows of shopping carts, in which case retention member 154 would be equipped with a second array of sensors to detect the second row of carts, or the range of sensors 160, 162, 164, 166, and 168 could be increased. The corral may also comprise two parallel but separate storage areas, each with its own sensor array. As shown, the sensors are unidirectional, with the hemispherical zones of detection directed only toward the interior of the corral bounded by retention members 153 and 154, so that the control module 170 need not account for detection of objects outside of the corral such as cars and shopping carts not properly stored.

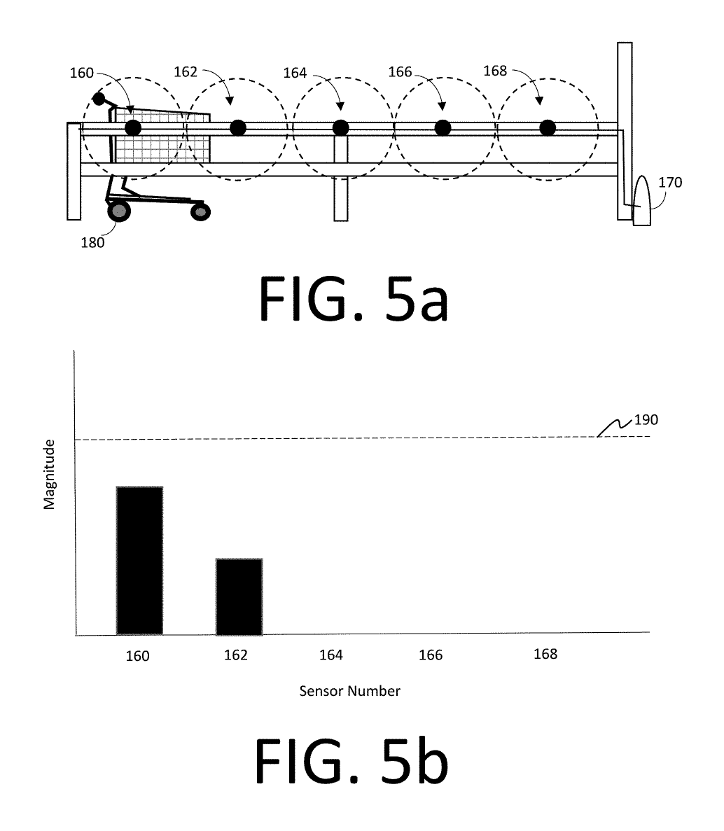

FIG. 5a illustrates a scenario in which a single shopping cart 180 is placed in a cart corral, near the open end. Sensor 160 and 162 each detect the cart, with sensor 160 detecting a signal of greater magnitude due to the majority of the cart's mass is disposed in its zone. FIG. 5b illustrates corresponding readings sent from the plurality of sensors 160, 162, 164, 166, and 169 to the control module 170. A threshold 190 is set to indicate adequate packing or nesting of carts within a given zone of detection. As shown by FIG. 5b, although single cart 180 is detected by both sensors 160 and 162, the magnitude of the electromagnetic field detected by these sensors does not reach the threshold value 190. Sensors 164, 166, and 168 register no significant electromagnetic field. The control module 170 may compare the readings from the sensors to stored value in order to estimate the number of carts present in the corral. Due to the detected placement of a cart near the open end of the corral with detected empty space toward the closed end, the control module 170 may be programmed to generate an alert indicating that the cart 180 should be pushed toward the closed end of the corral to make room for other carts. On the other hand, since a customer may easily move a single cart, the control module 170 may be programmed to take no action when sensors proximate the closed end of the corral fail detect any carts and the sensors proximate the open end detect only values below the preset threshold 190.

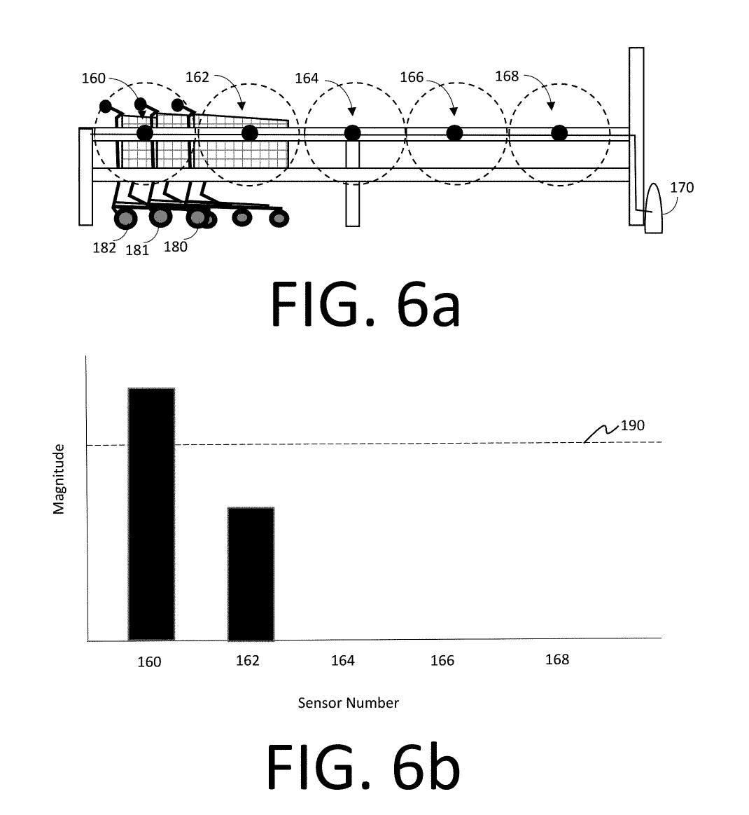

FIG. 6a illustrates the cart corral of FIG. 5a at another point in time, with FIG. 6b illustrating corresponding sensor readings. At this point in time, three shopping carts (180, 181, and 182) have been disposed proximate the open end of the cart corral, with no carts toward the closed end. As shown by FIG. 6b, sensors 164, 166 and 168 still register no significant values, but the magnitude detected by sensor 160 now exceeds the threshold value 190 due to the increased mass of metal within the zone detected by sensor 160. In this scenario, the control module 170 may be programmed to generate an alert indicating that shopping carts should be pushed inward or otherwise removed from the entrance.

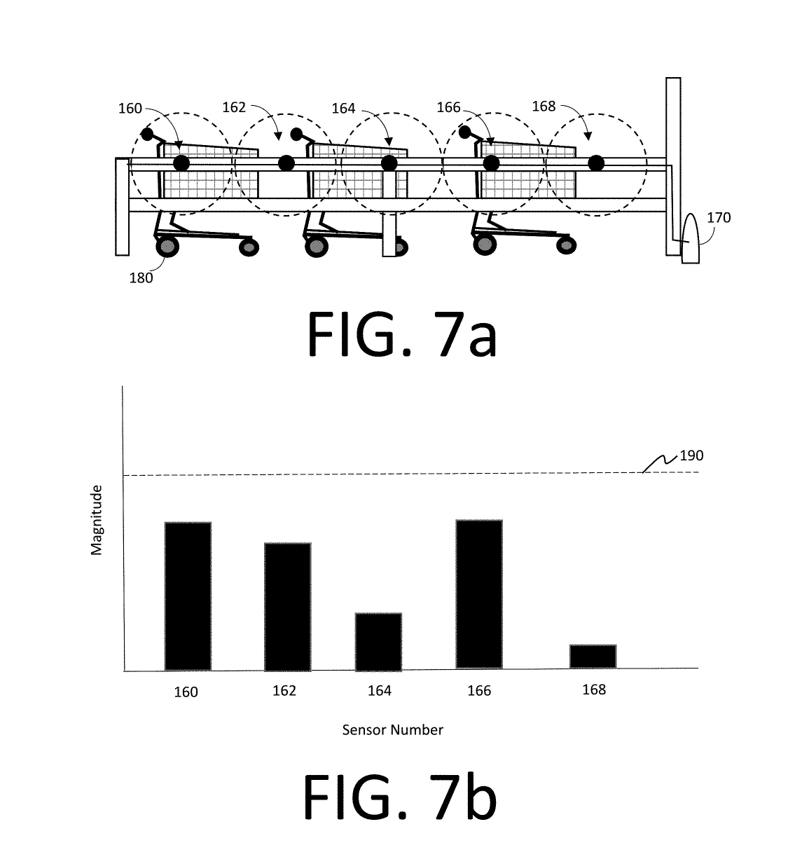

FIG. 7a illustrates a scenario in which carts are positioned throughout the length of the cart corral, but are not tightly nested. As shown in FIG. 7b, each of sensors 160, 162, 164, 166, and 168 register values based on the magnitude of electromagnetic fields detected, but none meet the threshold value 190. The control module 170 recognizes this as indicative of a cart density below the optimal or desired density, and may be programmed to generate an alert indicating that the carts should be compacted toward the closed corral end to make room for more carts toward the open end.

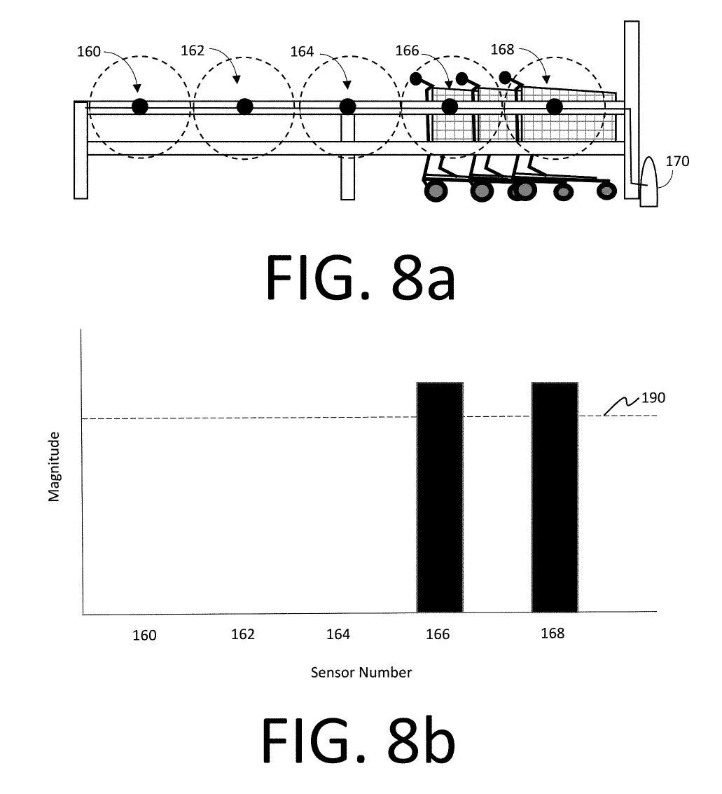

FIG. 8a illustrates a scenario in which three carts are tightly nested toward the closed end. This is the desired placement of carts and is recognized as such in FIG. 8b by detected values for sensors 166 and 168, proximate the closed end, of the corral exceeding the preset threshold value 190 while sensors 160, 162, and 164, which are closer to the open end, register no values of significance.

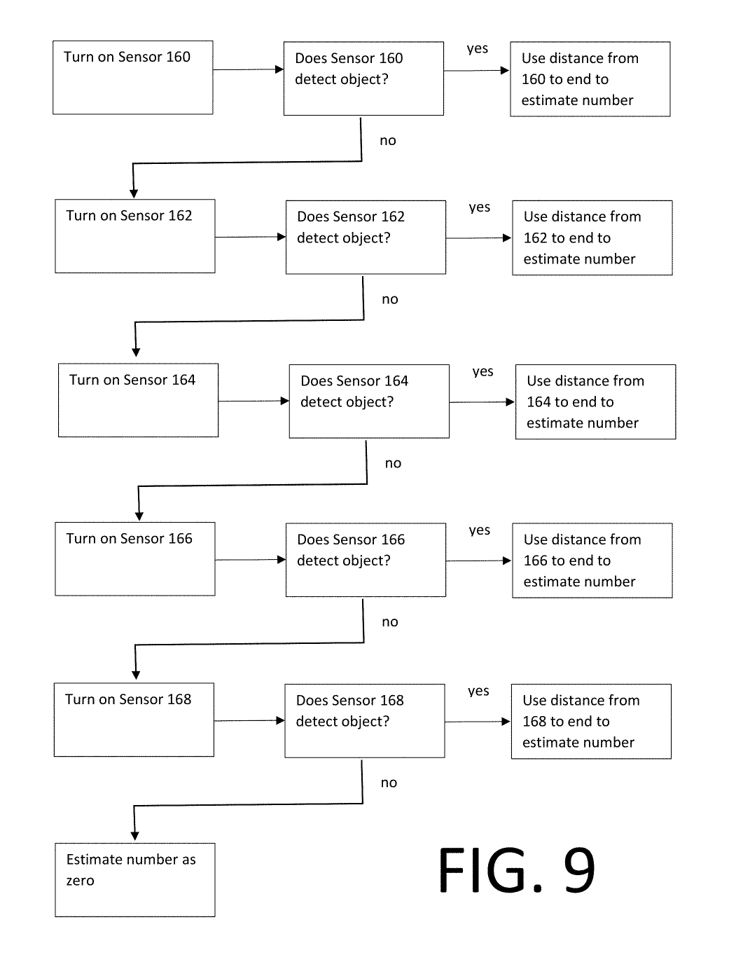

FIG. 9 illustrates an alternative method of estimating the number of shopping carts in which the array of sensors from FIGS. 3-8 are sequentially activated from the open end of the corral inward to determine how far toward the open end of the corral carts extend. First the sensor closest to the entrance, sensor 160, is activated. If sensor 160 detects the presence of an object in its zone, the distance from sensor 160 to the end is used to estimate the number of carts present by comparison to the number of carts that may be stored within that distance. If sensor 160 does not detect an object, sensor 162 is activated and goes through the same process. This process continues until one of the sensors detects an object within its zone. If the last sensor, in this case sensor 168, fails to detect an object, then the number of carts is estimated as zero. In some embodiments, subsequent sensors may be activated even when a previous sensor detects objects, so that subsequent empty zones may be subtracted from the estimated number in order to improve accuracy.

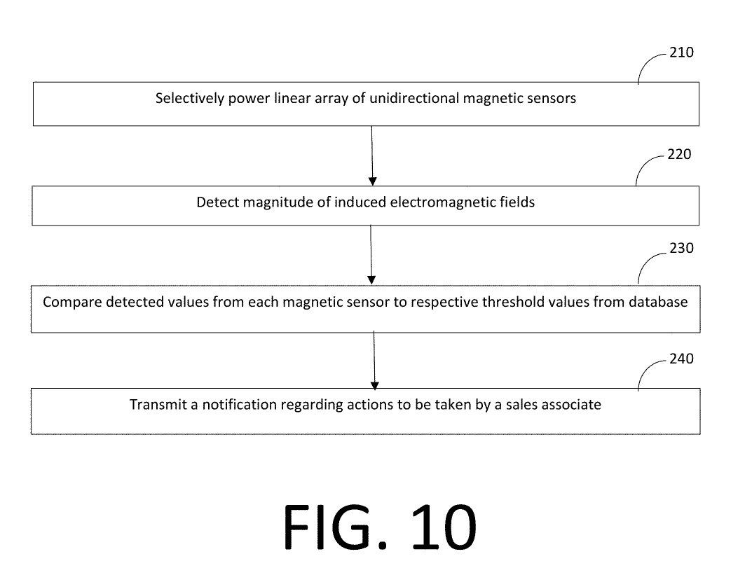

FIG. 10 illustrates one example of a method of monitoring shopping carts within a storage area. First, a linear array of unidirectional magnetic sensors is powered on and off such that when powered on a range of each sensor is limited to the storage area (Step 210). When the array is powered on, it detects the magnitude of induced electromagnetic fields (Step 220). The magnetic sensors of the array are spaced apart along the length of the shopping cart storage area with each magnetic sensor at approximately the same vertical position in order to ensure consistent readings. Next, the detected values from each magnetic sensor are compared by a control circuit to respective threshold values from a database (Step 230). The control circuit then transmits a notification regarding actions to be taken by a sales associate based on the comparison of the detected values to the threshold values (Step 240).

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An apparatus for detecting shopping carts in a shopping cart storage area of a retail facility, the apparatus comprising:
a shopping cart storage unit comprising:
an open end configured to receive and dispense the shopping carts;
a closed end opposite the open end and configured to contain the shopping carts in a storage volume between the open end and the closed end;
at least two generally parallel retention members connecting portions of the open end to corresponding portions of the closed end, each retention member having a length and spaced apart from each other by a width, to form the storage volume having a length and width sized to receive a plurality of shopping carts organized in one or more single-file lines between the generally parallel retention members; and
a linear array of unidirectional magnetic sensors configured to detect a magnitude of an induced electromagnetic field, wherein the magnitude of the induced electromagnetic field varies depending on a presence of metal objects in the storage volume, the unidirectional magnetic field sensors spaced apart along the length of at least one retention member at approximately the same vertical position and oriented to face the storage volume and not face volumes outside of the storage volume;
a power source coupled to the linear array of unidirectional magnetic field sensors;
an electronic control circuit comprising a computer memory and being physically coupled to the linear array of unidirectional magnetic field sensors, wherein the electronic control circuit is in communication with a database correlating combinations of threshold values to store management options, the electronic control circuit configured to:
control power to each of the unidirectional magnetic field sensors such that one or more of the sensors are selectively powered on and off and such that when powered a range of each sensor is limited to the storage volume;
compare detected values obtained from each magnetic sensor to the threshold values from the database; and
select at least one store management option based on a comparison of the detected values to the threshold values; and
a wireless transmitter for transmitting information from the control circuit to one or more devices monitored by one or more sales associates.

2. The apparatus of claim 1, wherein the magnetic sensors are positioned about 2 to about 4 inches apart along substantially the entire length of the at least one retention member.

3. The apparatus of claim 1, wherein each magnetic sensor uses 5.5 mW or less.

4. The apparatus of claim 1, wherein the array of sensors alternates between on and off states at predetermined time intervals.

5. The apparatus of claim 1, further comprising at least one solar cell coupled to at least one sensor.

6. The apparatus of claim 1, wherein the sensors comprise lead shields that limit detection of the sensors.

7. The apparatus of claim 1, wherein the control circuit is further configured to generate an alert when a first magnetic sensor at a location proximate the open end of the storage area detects an electromagnetic field exceeding its respective threshold value and a second magnetic sensor further from the open end does not detect an electromagnetic field exceeding its respective threshold value.

8. The apparatus of claim 1, wherein the control circuit is further configured to generate an alert when the detected value of a preset number of sensors are at or above the respective threshold values for each magnetic sensor.

9. The apparatus of claim 1, further comprising database information correlating electromagnetic field values to a quantity of shopping carts proximate a sensor, wherein the control circuit is further configured to transmit to the display device information regarding an estimated number of shopping carts based on detected values from the plurality of sensors.

10. The apparatus of claim 1, wherein the control circuit is further configured to estimate a number of shoppers based on changes in the estimated number of shopping carts.

11. An apparatus for estimating a quantity of stored shopping carts in a shopping cart storage area of a retail facility, the apparatus comprising:
a shopping cart storage unit comprising:
an open end configured to receive and dispense the shopping carts;
a closed end opposite the open end and configured to contain the shopping carts in a storage volume between the open end and the closed end;
at least two generally parallel retention members connecting portions of the open end to corresponding portions of the closed end, each retention member having a length and spaced apart from each other by a width, to form the storage volume having a length and width sized to receive a plurality of shopping carts organized in one or more single-file lines between the generally parallel retention members; and
a linear array of unidirectional magnetic field sensors configured to detect a magnitude of an induced electromagnetic field, wherein the magnitude of the induced electromagnetic field varies depending on a presence of metal objects in the storage volume, the unidirectional magnetic field at approximately the same vertical position and oriented to face the storage volume and not face volumes outside of the storage volume, the magnetic sensors spaced apart along the length of at least one retention member and each supplied with an amount of power from a power source so that zones of respective magnetic sensors do not overlap; and
an electronic control circuit comprising a computer memory positioned at the storage area and physically coupled to the plurality of magnetic sensors;
wherein the control circuit is configured to generate a notification identifying each of the magnetic sensors that detect an electromagnetic field exceeding a preset magnitude within a time window.

12. The apparatus of claim 11, wherein the control circuit is configured to generate a notification to retrieve the carts when all magnetic sensors detect an electromagnetic field exceeding the preset magnitude.

13. The apparatus of claim 11, wherein the control circuit is configured to generate a notification to adjust the carts when one or more magnetic sensors proximate the open end detect an electromagnetic field exceeding the preset magnitude and one or more magnetic sensors further from the open end do not detect an electromagnetic field exceeding the preset magnitude.

14. The apparatus of claim 11, wherein the control circuit is further configured to generate a notification based on the number of magnetic sensors which, within the time window, first detected an electromagnetic field exceeding the preset magnitude and later did not detect an electromagnetic field exceeding the preset magnitude.

15. A method for monitoring shopping carts in storage area of a retail facility, the method comprising:
selectively powering on and off a linear array of unidirectional magnetic sensors such that when powered a range of each sensor is limited to the storage area;
detecting a magnitude of induced electromagnetic fields through the linear array of unidirectional magnetic sensors, the magnetic sensors spaced apart along the length of a shopping cart storage area with each magnetic sensor at approximately the same vertical position;
through a control circuit, comparing detected values from each magnetic sensor to respective threshold values from a database; and
transmitting a notification regarding actions to be taken by a sales associate based on a comparison of the detected values to the threshold values.

16. The method of claim 15, wherein the notification comprises an instruction to compact the shopping carts when a first magnetic sensor of the array at a location proximate an open end of the storage area detects an electromagnetic field exceeding its respective threshold value and a second magnetic sensor further from the open end does not detect an electromagnetic field exceeding its respective threshold value.

17. The method of claim 15, wherein the notification comprises an instruction to retrieve the shopping carts when the detected value of a preset number of sensors are at or above the respective threshold values for each magnetic sensor.

18. The method of claim 15, further comprising estimating a quantity of shopping carts in the storage area by comparing the detected values to cart estimates from the database.

19. The method of claim 15, further comprising estimating a quantity of shoppers at the retail facility based on changes in the detected values over time.

20. The method of claim 15, further comprising estimating a quantity of shoppers at the retail facility based on changes in the detected values over time from magnetic sensors from a plurality of arrays each associated with a respective cart storage area.
